(19) United States
(12) Patent Application Publication
(10) Pub. No.: US 2013/0289192 A1
(43) Pub. Date: Oct. 31, 2013

(54) PC/ABS COMPOSITIONS THAT ARE STABLE TO PROCESSING

(71) Applicant: BAYER INTELLECTUAL PROPERTY GMBH, Monheim (DE)

(72) Inventors: Andreas Seidel, Dormagen (DE); Thomas Eckel, Dormagen (DE); Martin Haussler, Remscheid (DE)

(73) Assignee: BAYER INTELLECTUAL PROPERTY GMBH, Monheim (DE)

(21) Appl. No.: 13/867,953

(22) Filed: Apr. 22, 2013

(30) Foreign Application Priority Data
Apr. 27, 2012 (EP) 12166034.4

(51) Int. Cl. C08L 69/00

(52) U.S. Cl. CPC C08L 69/00
USPC 524/504

(57) ABSTRACT

The present invention relates to moulding compositions comprising polycarbonate and acrylonitrile-butadiene-styrene polymer (ABS) as well as optionally further additives and components, which moulding compositions are distinguished by high thermal processing stability in respect of gloss level, polycarbonate degradation and content of free bisphenol A and exhibit improved stress cracking resistance.

### CROSS REFERENCE TO RELATED APPLICATION

This application claims priority to European Patent Application No. 12166034.4, filed Apr. 27, 2012, the content of which is incorporated herein by reference in its entirety.

### BACKGROUND

1. Field of the Invention

The present invention relates to moulding compositions comprising polycarbonate and acrylonitrile-butadiene-styrene polymer (ABS) as well as optionally further additives and components, which moulding compositions are distinguished by high thermal processing stability in respect of gloss level, polycarbonate degradation and content of free bisphenol A and exhibit improved stress cracking resistance.

2. Description of Related Art

Thermoplastic moulding compositions of polycarbonates and ABS polymers have been known for a long time.

DE-A 1 170 141 describes readily processable moulding compositions of polycarbonates and graft polymers of monomer mixtures of acrylonitrile and an aromatic vinyl hydrocarbon on polybutadiene.

DE-A 1 810 993 describes the improved heat stability of polycarbonate in admixture with ABS graft polymers or copolymers based on α-methylstyrene.

The subject-matter of DE-A 22 59 565 and DE-A 23 29 548 is the improved joint line strength of PC/ABS moulding compositions, graft polymers of a specific particle size being used in both documents as a constituent of the ABS component.

DE-A 28 18 679 describes PC/ABS mixtures having particularly high low-temperature strength when the ABS polymer contains two graft mixed polymers with different degrees of grafting.

EP-A 900 827 discloses impact-modified polycarbonate compositions having improved heat stability, comprising emulsion polymers which are substantially free of any basic components that degrade the polycarbonate. According to that application, such polycarbonate compositions impact-modified with emulsion polymers that comprise basic impurities resulting from their preparation exhibit inadequate heat stability.

U.S. Pat. No. 6,417,256 B1 describes moulding compositions comprising polycarbonate and ABS graft polymer prepared by the solution polymerisation process, which moulding compositions are distinguished by excellent mechanical properties and in particular improved stress cracking behaviour.

EP 1 268 666 B1 and WO 01/25334 A1 describe moulding compositions comprising polycarbonate and ABS graft polymer prepared by the mass polymerisation process, which moulding compositions are distinguished by good impact strength and improved processing behaviour.

WO 01/70884 A1 describes moulding compositions comprising polycarbonate and ABS graft polymer prepared by the mass polymerisation process, which moulding compositions are distinguished by reduced anisotropy in respect of the impact strength.

WO 91/18052 A1 discloses PC/ABS moulding compositions having high heat stability, in which the ABS polymer has a content of sodium and potassium ions of less than 800 ppm.

WO 99/11713 A1 discloses flame-resistant PC/ABS compositions having improved moisture resistance, in which the ABS polymer has an alkali metal content of less than 1 ppm.

In none of the above-mentioned documents is it described that the compositions of the present invention exhibit advantageous properties over the compositions known in the prior art.

### SUMMARY

An object of the present invention was to provide polycarbonate/ABS moulding compositions which are distinguished by improved stress cracking resistance, a high gloss level that is more stable to processing, and preferably also lower thermal polycarbonate degradation under disadvantageous processing conditions (high temperature, high shear and/or long dwell time) and a reduced content of free bisphenol A, even under severe compounding conditions (high temperatures).

The invention accordingly provides thermoplastic moulding compositions comprising
A) from 40.0 to 99.5 parts by weight, preferably from 50.0 to 95.0 parts by weight, particularly preferably from 60.0 to 90.0 parts by weight, of at least one aromatic polycarbonate or polyester carbonate having an OH end group content of less than 300 ppm, preferably less than 250 ppm, particularly preferably less than 200 ppm,
B) from 0.5 to 60.0 parts by weight, preferably from 4.5 to 49.5 parts by weight, particularly preferably from 6.0 to 36.0 parts by weight, of at least one graft polymer having a content of lithium, sodium, potassium, magnesium and calcium of less than 100 ppm in total, more preferably less than 50 ppm in total, particularly preferably less than 20 ppm in total,
C) from 0.0 to 30.0 parts by weight, preferably from 0 to 20.0 parts by weight, particularly preferably from 3.0 to 15.0 parts by weight, of vinyl (co)polymer, preferably prepared by the mass or solution polymerisation process,
D) from 0.0 to 40.0 parts by weight, preferably from 0.5 to 20.0 parts by weight, particularly preferably from 1.0 to 10.0 parts by weight, of further polymer additives,
wherein the sum of the parts by weight of components A) to D) is 100 parts by weight.

### DETAILED DESCRIPTION OF A PREFERRED EMBODIMENT

In a further preferred embodiment, component A has a content of free bisphenol A (BPA) of less than 20 ppm, preferably less than 15 ppm and more preferably less than 10 ppm.

Component A is preferably prepared by the interfacial process.

Component B is preferably prepared by the mass or solution polymerisation process.

In a further preferred embodiment, the compositions according to the invention are free of aromatic polycarbonate or polyester carbonate prepared by the melt polymerisation process.

In a further preferred embodiment, the compositions according to the invention are free of graft polymers prepared by the emulsion or suspension polymerisation process.

In a further preferred embodiment, the compositions according to the invention are free of vinyl (co)polymers prepared by the emulsion or suspension polymerisation process.

In a particularly preferred embodiment, the compositions according to the invention are both free of aromatic polycarbonate or polyester carbonate prepared by the melt polymerisation process and free of graft polymers and vinyl (co)polymers prepared by the emulsion or suspension polymerisation process.

In a further preferred embodiment, the content of free bisphenol A in the compounded composition as a whole is less than 20 ppm, preferably less than 15 ppm, and preferably greater than 0.5 ppm, more preferably greater than 1.0 ppm, particularly preferably greater than 2 ppm.

In a preferred embodiment, the composition comprises components A to D.

In a preferred embodiment, the composition is free of components other than component A that contain free bisphenol A or bisphenol A constituents, in particular free of bisphenol-A-based flameproofing agents.

In a particularly preferred embodiment, the composition is free of flameproofing agents.

Unless indicated otherwise in the present invention, in order to determine the content of free bisphenol A the sample is dissolved in dichloromethane and reprecipitated with methanol. The precipitated polymer component is filtered off and the filtrate solution is concentrated. The content of free BPA is determined in the concentrated filtrate solution by HPLC with UV detection (external standard).

### Component A

Aromatic polycarbonates and/or aromatic polyester carbonates according to component A which are suitable according to the invention are known in the literature or can be prepared by processes known in the literature (for the preparation of aromatic polycarbonates see, for example, Schnell, “Chemistry and Physics of Polycarbonates”, Interscience Publishers, 1964 as well as DE-AS 1 495 626, DE-A 2 232 877, DE-A 2 703 376, DE-A 2 714 544, DE-A 3 000 610, DE-A 3 832 396; for the preparation of aromatic polyester carbonates see e.g. DE-A 3 007 934).

The preparation of aromatic polycarbonates according to component A is carried out preferably by reaction of diphenols with carbonic acid halides, preferably phosgene, and/or with aromatic dicarboxylic acid dihalides, preferably benzenedicarboxylic acid dihalides, by the interfacial process, optionally using chain terminators, for example monophenols, and optionally using branching agents having a functionality of three or more than three, for example triphenols or tetraphenols.

The polycarbonates which are suitable according to the invention as component A have an OH end group concentration of less than 300 ppm, preferably less than 250 ppm, particularly preferably less than 200 ppm.

The determination of the OH end group concentration is carried out by means of infrared spectroscopy according to Horbach, A.; Veiel, U.; Wunderlich, H., Makromolekulare Chemie 1965, Volume 88, p. 215-231.

Diphenols for the preparation of the aromatic polycarbonates and/or aromatic polyester carbonates are preferably those of formula (I)

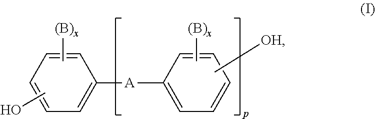

wherein

A represents a single bond, C₁- to C₅-alkylene, C₂- to C₅-alkylidene, C₅- to C₆-cycloalkylidene, —O—, —SO—, —CO—, —S—, —SO₂—, C₆- to C₁₂-arylene, to which there can be fused further aromatic rings optionally containing heteroatoms,
or a radical of formula (II) or (III)

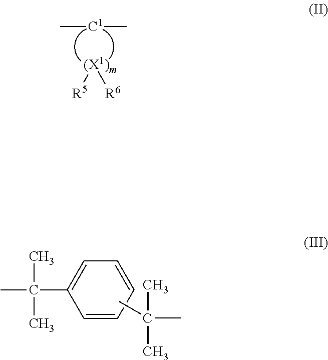

B in each case represents C1- to C12-alkyl, preferably methyl, halogen, preferably chlorine and/or bromine,
x in each case independently of one another represents 0, 1 or 2,
p represents 1 or 0, and
R5 and R6 can be chosen individually for each X1 and, independently of one another, represent hydrogen or C1- to C6-alkyl, preferably hydrogen, methyl or ethyl,
X1 represents carbon and
m represents an integer from 4 to 7, preferably 4 or 5, with the proviso that on at least one atom X1, R5 and R6 are simultaneously alkyl, preferably methyl or ethyl.

Preferred diphenols are hydroquinone, resorcinol, dihydroxydiphenols, bis-(hydroxyphenyl)-C1-C5-alkanes, bis-(hydroxyphenyl)-C5-C6-cycloalkanes, bis-(hydroxyphenyl) ethers, bis-(hydroxyphenyl) sulfoxides, bis-(hydroxyphenyl) ketones, bis-(hydroxyphenyl)-sulfones and α,α-bis-(hydroxyphenyl)-diisopropyl-benzenes as well as derivatives thereof brominated and/or chlorinated on the ring.

Particularly preferred diphenols are 4,4′-dihydroxydiphenyl, bisphenol A, 2,4-bis(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-dihydroxydiphenylsulfone as well as di- and tetra-brominated or chlorinated derivatives thereof, such as, for example, 2,2-bis(3-chloro-4-hydroxyphenyl)-propane, 2,2-bis-(3,5-dichloro-4-hydroxyphenyl)-propane or 2,2-bis-(3,5-dibromo-4-hydroxyphenyl)-propane. Particular preference is given to 2,2-bis-(4-hydroxyphenyl)-propane (bisphenol A).

The diphenols can be used individually or in the form of arbitrary mixtures. The diphenols are known in the literature or are obtainable by processes known in the literature.

Chain terminators suitable for the preparation of the thermoplastic, aromatic polycarbonates are, for example, phenol, p-chlorophenol, p-tert-butylphenol or 2,4,6-tribromophenol, but also long-chained alkylphenols, such as 4-[2-(2,4,4-trimethylpentyl)]-phenol, 4-(1,3-tetramethylbutyl)-phenol according to DE-A 2 842 005 or monoalkylphenol or dialkylphenols having a total of from 8 to 20 carbon atoms in the alkyl substituents, such as 3,5-di-tert-butyl-phenol, p-isooctylphenol, p-tert-octylphenol, p-dodecylphenol and 2-(3,5-dimethylheptyl)-phenol and 4-(3,5-dimethylheptyl)-phenol. The amount of chain terminators to be used is generally from 0.5 mol % to 10 mol %, based on the molar sum of the diphenols used in each particular case.

The relative solution viscosity (ηrel) of the aromatic polycarbonates for the preparation of the composition is in the range from 1.18 to 1.4, preferably from 1.20 to 1.32, more preferably from 1.23 to 1.32, particularly preferably from 1.26 to 1.30 (measured on solutions of 0.5 g of polycarbonate or polyester carbonate in 100 ml of methylene chloride solution at 25° C. in an Ubbelohde viscometer).

The thermoplastic, aromatic polycarbonates preferably have mean weight-average molecular weights (Mw, measured by GPC (gel permeation chromatography) with polycarbonate standard) of from 10,000 to 200,000 g/mol, preferably from 15,000 to 80,000 g/mol, more preferably from 23,000 to 32,000 g/mol, particularly preferably from 26,000 to 32,000 g/mol.

The thermoplastic, aromatic polycarbonates can be branched in known manner, preferably by the incorporation of from 0.05 to 2.0 mol %, based on the sum of the diphenols used, of compounds having a functionality of three or more than three, for example those having three or more phenolic groups. Preference is given to the use of linear polycarbonates, more preferably based on bisphenol A.

Both homopolycarbonates and copolycarbonates are suitable. For the preparation of copolycarbonates of component A according to the invention, from 1 to 25 wt. %, preferably from 2.5 to 25 wt. %, based on the total amount of diphenols to be used, of polydiorganosiloxanes having hydroxyaryloxy end groups can also be used. These are known (U.S. Pat. No. 3,419,634) and can be prepared by processes known in the literature. Copolycarbonates comprising polydiorganosiloxanes are also suitable; the preparation of copolycarbonates comprising polydiorganosiloxanes is described, for example, in DE-A 3 334 782.

Preferred polycarbonates, in addition to the bisphenol A homopolycarbonates, are the copolycarbonates of bisphenol A having up to 15 mol %, based on the molar sums of diphenols, of diphenols other than those mentioned as being preferred or particularly preferred.

Aromatic dicarboxylic acid dihalides for the preparation of aromatic polyester carbonates are preferably the diacid dichlorides of isophthalic acid, terephthalic acid, diphenyl ether 4,4′-dicarboxylic acid and naphthalene-2,6-dicarboxylic acid.

Particular preference is given to mixtures of the diacid dichlorides of isophthalic acid and terephthalic acid in a ratio of from 1:20 to 20:1.

In the preparation of polyester carbonates a carbonic acid halide, preferably phosgene, is additionally used concomitantly as bifunctional acid derivative.

There come into consideration as chain terminators for the preparation of the aromatic polyester carbonates, in addition to the monophenols already mentioned, also the chlorocarbonic acid esters thereof as well as the acid chlorides of aromatic monocarboxylic acids, which can optionally be substituted by C1- to C22-alkyl groups or by halogen atoms, as well as aliphatic C2- to C22-monocarboxylic acid chlorides.

The amount of chain terminators is in each case from 0.1 to 10 mol %, based in the case of phenolic chain terminators on moles of diphenol and in the case of monocarboxylic acid chloride chain terminators on moles of dicarboxylic acid dichloride.

One or more aromatic hydroxycarboxylic acids can additionally be used in the preparation of aromatic polyester carbonates.

The aromatic polyester carbonates can be both linear and branched in a known manner (see in this connection DE-A 2 940 024 and DE-A 3 007 934), preference being given to linear polyester carbonates.

There can be used as branching agents, for example, carboxylic acid chlorides having a functionality of three or more, such as trimesic acid trichloride, cyanuric acid trichloride, 3,3′-4,4′-benzophenone-tetracarboxylic acid tetrachloride, 1,4,5,8-naphthalenetetracarboxylic acid tetrachloride or pyromellitic acid tetrachloride, in amounts of from 0.01 to 1.0 mol % (based on dicarboxylic acid dichlorides used), or phenols having a functionality of three or more, such as phloroglucinol, 4,6-dimethyl-2,4,6-tri-(4-hydroxyphenyl)-hept-2-ene, 4,6-dimethyl-2,4,6-tri-(4-hydroxyphenyl)-heptane, 1,3,5 -tri-(4-hydroxyphenyl)-benzene, 1,1,1-tri-(4-hydroxyphenyl)-ethane, tri-(4-hydroxyphenyl)-phenylmethane, 2,2-bis[4,4-bis(4-hydroxy-phenyl)-cyclohexyl]-propane, 2,4-bis(4-hydroxyphenyl-isopropyl)-phenol, tetra-(4-hydroxyphenyl)-methane, 2,6-bis(2-hydroxy-5-methyl-benzyl)-4-methyl-phenol, 2-(4-hydroxyphenyl)-2-(2,4-dihydroxyphenyl)-propane, tetra-(4-[4-hydroxyphenyl-isopropyl]-phenoxy)-methane, 1,4-bis[4,4′-dihydroxytriphenyl)-methyl]-benzene, in amounts of from 0.01 to 1.0 mol %, based on diphenols used. Phenolic branching agents can be placed in a reaction vessel with the diphenols, acid chloride branching agents can be introduced together with the acid dichlorides.

The amount of carbonate structural units in the thermoplastic, aromatic polyester carbonates can vary as desired. Preferably, the amount of carbonate groups is up to 100 mol %, in particular up to 80 mol %, particularly preferably up to 50 mol %, based on the sum of ester groups and carbonate groups. Both the esters and the carbonates contained in the aromatic polyester carbonates can be present in the polycondensation product in the form of blocks or distributed randomly.

The thermoplastic, aromatic polycarbonates and polyester carbonates can be used alone or in an arbitrary mixture.

### Component B

The compositions according to the invention comprise as component B graft polymers prepared by the emulsion, mass, solution or suspension polymerisation process.

The graft polymers suitable as component B are distinguished by a content of lithium, sodium, potassium, magnesium and calcium of less than 100 ppm in total, more preferably less than 50 ppm in total, particularly preferably less than 20 ppm in total.

The content of lithium, sodium, potassium, magnesium and calcium is determined by optical emission spectrometry by means of inductively coupled plasma (ICP-OES) with an internal standard. To that end, the sample is decomposed in concentrated nitric acid in a microwave at 200° C. and 200 bar, diluted to 1 M nitric acid and measured.

In the compositions according to the invention there is preferably used as component B a graft polymer prepared by the mass or solution polymerisation process.

In a preferred embodiment, such a graft polymer is preferably graft polymers of
B1) from 5 to 95 wt. %, preferably from 80 to 93 wt. %, particularly preferably from 83 to 92 wt. %, most particularly preferably from 85 to 91 wt. %, based on component B, of a mixture of
B1.1) from 65 to 85 wt. %, preferably from 70 to 80 wt. %, based on the mixture B.1, of at least one monomer selected from the group of the vinyl aromatic compounds (such as, for example, styrene, α-methylstyrene), vinyl aromatic compounds substituted on the ring (such as, for example, p-methylstyrene, p-chlorostyrene) and methacrylic acid (C1-C8)-alkyl esters (such as, for example, methyl methacrylate, ethyl methacrylate) and
B1.2) from 15 to 35 wt. %, preferably from 20 to 30 wt. %, based on the mixture B1, of at least one monomer selected from the group of the vinyl cyanides (such as, for example, unsaturated nitriles such as acrylonitrile and methacrylonitrile), (meth)acrylic acid (C1-C8)-alkyl esters (such as, for example, methyl methacrylate, n-butyl acrylate, tert-butyl acrylate) and derivatives (such as, for example, anhydrides and imides) of unsaturated carboxylic acids (for example maleic anhydride and N-phenyl-maleimide)
on
B2) from 95 to 5 wt. %, preferably from 20 to 7 wt. %, particularly preferably from 17 to 8 wt. %, most particularly preferably from 15 to 9 wt. %, based on component B,
of at least one graft base.

The graft base preferably has a glass transition temperature <0° C., more preferably <−50° C., particularly preferably <−70° C.

Unless indicated otherwise in the present invention, glass transition temperatures are determined by means of differential scanning calorimetry (DSC) according to standard DIN EN 61006 at a heating rate of 10 K/min with definition of the Tg as the mid-point temperature (tangent method) and nitrogen as protecting gas.

The graft particles in component B preferably have a mean particle size (D50 value) of from 0.1 to 10 μm, preferably from 0.2 to 2 μm, particularly preferably from 0.3 to 1.0 μm, most particularly preferably from 0.4 to 0.8 μm.

The mean particle size D50 is the diameter above and below which in each case 50 wt. % of the particles lie. Unless explicitly indicated otherwise in the present application, it is determined by means of ultracentrifuge measurement (W. Scholtan, H. Lange, Kolloid, Z. and Z. Polymere 250 (1972), 782-1796).

Preferred monomers B1.1 are selected from at least one of the monomers styrene, α-methylstyrene and methyl methacrylate; preferred monomers B1.2 are selected from at least one of the monomers acrylonitrile, maleic anhydride and methyl methacrylate.

Particularly preferred monomers are B1.1 styrene and B1.2 acrylonitrile.

Preferred graft bases B2 are diene rubbers (e.g. based on butadiene or isoprene), diene-vinyl block copolymer rubbers (e.g. based on butadiene and styrene blocks), copolymers of diene rubbers with further copolymerisable monomers (e.g. according to B1.1 and B1.2) and mixtures of the above-mentioned types of rubbers. Pure polybutadiene rubbers, styrene-butadiene block copolymer rubbers and mixtures of styrene-butadiene block copolymer rubbers with pure polybutadiene rubber are particularly preferred as the graft base B2.

The gel content of the graft polymers B is preferably from 10 to 40 wt. %, particularly preferably from 15 to 30 wt. %, most particularly preferably from 17 to 25 wt. % (measured in acetone).

Unless indicated otherwise in the present invention, the gel content of the graft polymers is determined at 25° C. as the fraction that is insoluble in acetone as solvent (M. Hoffmann, H. Krömer, R. Kuhn, Polymeranalytik I and II, Georg Thieme-Verlag, Stuttgart 1977).

Further preferred polymers B are, for example, ABS polymers prepared by radical polymerisation, which in a preferred embodiment comprise up to 10 wt. %, particularly preferably up to 5 wt. %, particularly preferably from 2 to 5 wt. %, in each case based on the graft polymer B, of n-butyl acrylate.

The graft polymer B generally comprises, resulting from its preparation, free copolymer of B1.1 and B1.2, that is to say copolymer that is not chemically bonded to the rubber base, which is distinguished in that it can be dissolved in suitable solvents (e.g. acetone).

Component B preferably comprises free copolymer of B1.1 and B1.2 which has a weight-average molecular weight (Mw), determined by gel permeation chromatography with polystyrene as standard, of preferably from 50,000 to 200,000 g/mol, particularly preferably from 70,000 to 180,000 g/mol, most particularly preferably from 100,000 to 170,000 g/mol.

### Component C

### Component C Comprises One or More Thermoplastic Vinyl (Co)Polymers C.

Suitable as vinyl (co)polymers C are polymers of at least one monomer from the group of the vinyl aromatic compounds, vinyl cyanides (unsaturated nitriles), (meth)acrylic acid (C1-C8)-alkyl esters, unsaturated carboxylic acids and derivatives (such as anhydrides and imides) of unsaturated carboxylic acids. Particularly suitable are (co)polymers of
C.1 from 50 to 99 parts by weight, preferably from 70 to 80 parts by weight, of vinyl aromatic compounds and/or vinyl aromatic compounds substituted on the ring, such as styrene, α-methylstyrene, p-methylstyrene, p-chlorostyrene, and/or (meth)acrylic acid (C1-C8)-alkyl esters, such as methyl methacrylate, ethyl methacrylate, and
C.2 from 1 to 50 parts by weight, preferably from 20 to 30 parts by weight, of vinyl cyanides (unsaturated nitriles), such as acrylonitrile and methacrylonitrile, and/or (meth)acrylic acid (C1-C8)-alkyl esters, such as methyl methacrylate, n-butyl acrylate, tert-butyl acrylate, and/or unsaturated carboxylic acids, such as maleic acid, and/or derivatives, such as anhydrides and imides, of unsaturated carboxylic acids, for example maleic anhydride and N-phenylmaleimide.

The vinyl (co)polymers C are resin-like, thermoplastic and rubber-free. The copolymer of C.1 styrene and C.2 acrylonitrile is particularly preferred.

The (co)polymers according to C are known and can be prepared by radical polymerisation, in particular by emulsion, suspension, solution or mass polymerisation, preferably by solution or mass polymerisation. The (co)polymers preferably have mean molecular weights Mw (weight-average, determined by light scattering or sedimentation) of from 15,000 to 200,000 g/mol, particularly preferably from 80,000 to 150,000 g/mol.

### Component D

The composition can further optionally comprise as component D at least one commercially available polymer additive.

Suitable commercially available polymer additives according to component D are additives such as, for example, flameproofing agents (for example phosphorus compounds or halogen compounds), flameproofing synergists (for example nano-scale metal oxides), smoke-inhibiting additives (for example boric acid or borates), antidripping agents (for example compounds of the substance classes of the fluorinated polyolefins, the silicones and also aramid fibres), internal and external lubricants and demoulding agents (for example pentaerythritol tetrastearate, Montan wax or polyethylene wax), flowability aids (for example low molecular weight vinyl (co)polymers), antistatics (for example block copolymers of ethylene oxide and propylene oxide, other polyethers or polyhydroxy ethers, polyether amides, polyester amides or sulfonic acid salts), conductivity additives (for example conductive black or carbon nanotubes), stabilisers (for example UV/light stabilisers, heat stabilisers, antioxidants, transesterification inhibitors, hydrolytic stabilisers), additives having antibacterial action (for example silver or silver salts), additives that improve scratch resistance (for example silicone oils or hard fillers such as (hollow) ceramics beads or quartz powder), IR absorbers, optical brighteners, fluorescent additives, fillers and reinforcing materials (e.g. talc, ground glass fibres or carbon fibres, (hollow) glass or ceramics beads, mica, kaolin, CaCO3 and glass flakes), acids as well as colourants and pigments (for example carbon black, titanium dioxide or iron oxide) or mixtures of a plurality of the mentioned additives.

The compositions according to the invention can comprise as component D in particular also flameproofing agents, for example halogenated organic compounds or phosphorus-containing flameproofing agents. The last-mentioned are preferably used.

Phosphorus-containing flameproofing agents within the scope of the invention are preferably selected from the groups of the monomeric and oligomeric phosphoric and phosphonic acid esters, phosphonate amines and phosphazenes, it also being possible to use as flameproofing agents mixtures of a plurality of compounds selected from one or various of these groups. Other halogen-free phosphorus compounds not mentioned specifically here can also be used alone or in any desired combination with other halogen-free phosphorus compounds.

Preferred monomeric and oligomeric phosphoric or phosphonic acid esters are phosphorus compounds of the general formula (IV)

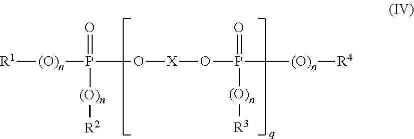

wherein
R1, R2, R3 and R4, independently of one another, each represent optionally halogenated C1- to C8-alkyl, or C5- to C6-cycloalkyl, C6- to C20-aryl or C7- to C12-aralkyl each optionally substituted by alkyl, preferably C1- to C4-alkyl, and/or by halogen, preferably chlorine, bromine,
each of the substituents n independently of the others represents 0 or 1,
q represents from 0 to 30 and
X represents a mono- or poly-nuclear aromatic radical having from 6 to 30 carbon atoms, or a linear or branched aliphatic radical having from 2 to 30 carbon atoms which can be OH-substituted and can contain up to 8 ether bonds.

R1, R2, R3 and R4, independently of one another, preferably represent C1- to C4-alkyl, phenyl, naphthyl or phenyl-C1-C4-alkyl. The aromatic groups R1, R2, R3 and R4 can in turn be substituted by halogen groups and/or by alkyl groups, preferably chlorine, bromine and/or C1- to C4-alkyl. Particularly preferred aryl radicals are cresyl, phenyl, xylenyl, propylphenyl or butylphenyl and the corresponding brominated and chlorinated derivatives thereof.
X in formula (IV) preferably represents a mono- or poly-nuclear aromatic radical having from 6 to 30 carbon atoms. This radical is preferably derived from diphenols of formula (I).

The substituents n in formula (IV), independently of one another, can be 0 or 1; n is preferably 1.
q represents values from 0 to 30. Where mixtures of different components of formula (IV) are used, mixtures preferably number-average q values of from 0.3 to 10, particularly preferably from 0.5 to 10, in particular from 1.05 to 1.4, can be used.
X particularly preferably represents

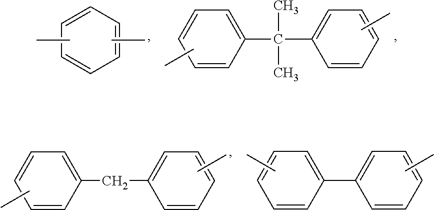

or chlorinated or brominated derivatives thereof X is derived in particular from resorcinol, hydroquinone, bisphenol A or diphenylphenol. X is particularly preferably derived from bisphenol A.

The use of oligomeric phosphoric acid esters of formula (IV) which are derived from bisphenol A is particularly advantageous.

In a further preferred embodiment there are used as additives sterically hindered phenols and phosphites or mixtures thereof, demoulding agents and pigments, preferably carbon black or titanium dioxide.

Particularly preferred moulding compositions comprise as component D, in addition to optional further additives, a demoulding agent, particularly preferably pentaerythritol tetrastearate, in an amount of from 0.1 to 1.5 parts by weight, preferably from 0.2 to 1.0 part by weight, particularly preferably from 0.3 to 0.8 part by weight.

Particularly preferred moulding compositions comprise as component D, in addition to optional further additives, at least one stabiliser, for example selected from the group of the sterically hindered phenols, phosphites and mixtures thereof, and particularly preferably Irganox® B900, in an amount of from 0.01 to 0.5 part by weight, preferably from 0.03 to 0.4 part by weight, particularly preferably from 0.06 to 0.3 part by weight.

Particularly preferred flameproofed compositions comprise as component D, in addition to optional further additives, a fluorinated polyolefin in an amount of from 0.05 to 5.0 parts by weight, preferably from 0.1 to 2.0 parts by weight, particularly preferably from 0.3 to 1.0 part by weight.

The combination of PTFE, pentaerythritol tetrastearate and Irganox B900 with a phosphorus-based flameproofing agent is further particularly preferred as component D).

The moulding compositions according to the invention comprising components A to C and optionally further additives D are prepared by mixing the constituents in known manner and melt compounding or melt extruding the mixture in conventional devices such as internal kneaders, extruders and twin-screw extruders at temperatures of from 200° C. to 330° C.

Accordingly, the present invention also provides a process for the preparation of thermoplastic moulding compositions comprising components A to D which, after mixing, are melt compounded or melt extruded in conventional devices at temperatures of from 200 to 330° C.

Mixing of the individual constituents can take place in known manner either in succession or simultaneously, either at about 20° C. (room temperature) or at a higher temperature.

The moulding compositions of the present invention can be used in the production of moulded bodies of any kind. In particular, moulded bodies can be produced by injection moulding. Examples of moulded bodies which can be produced are: casing parts of any kind, for example for domestic appliances, such as TV and hifi devices, coffee makers, mixers, office equipment, such as monitors or printers, or cover plates for the construction sector and parts for the automotive sector. They are additionally used in the field of electrical engineering, because they have very good electrical properties.

### Component A-1

Linear polycarbonate based on bisphenol A, prepared by the interfacial process, having a weight-average molecular weight M̅w of 27,000 g/mol (determined by GPC in dichloromethane with polycarbonate as standard), having an OH end group content of 150 ppm and having a content of free bisphenol A resulting from its preparation of 3 ppm.

### Component A-2

Linear polycarbonate based on bisphenol A, prepared by the melt polymerisation process, having a weight-average molecular weight M̅w of 27,000 g/mol (determined by GPC in dichloromethane with polycarbonate as standard), having an OH end group content of 480 ppm and having a content of free bisphenol A resulting from its preparation of 32 ppm.

### Component A-3

Component A-1 to which 29 ppm, based on component A-1, of additional free bisphenol A have been added. Component A-3 accordingly contains 32 ppm of free bisphenol A in total and the same OH end group content as component A-1.

### Component A-4

Component A-1 to which 114 ppm, based on component A-1, of additional free bisphenol A have been added. Component A-4 accordingly contains 117 ppm of free bisphenol A in total and the same OH end group content as component A-1.

### Component B-1

Graft polymer of the ABS type prepared by the mass polymerisation process, having an A:B:S ratio of 24:11:65 wt. %. The D50 value of the graft particle diameters, determined by ultracentrifugation, is 0.8 μm. The graft base underlying the graft polymer is a pure polybutadiene rubber. The gel content of the graft polymer, measured in acetone, is 22 wt. %. The weight-average molecular weight Mw, measured by GPC with polystyrene as standard in dimethylformamide at 20° C., of the free SAN, that is to say the SAN that is not bonded chemically to the rubber or included in the rubber particles in an acetone-insoluble form, is 150 kg/mol. The following alkali and alkaline earth metal contents were determined in this graft polymer by means of ICP-OES: Li<2 ppm, Na<2 ppm, K<2 ppm, Mg<1 ppm and Ca: 4 ppm (indications <x meaning that the element could not be detected with the particular detection limit of the analytical method).

### Component B-2

Precompound of 50 wt. % of an ABS graft polymer having a core-shell structure, prepared by emulsion polymerisation of 50 wt. %, based on the ABS graft polymer, of a mixture of 23 wt. % acrylonitrile and 77 wt. % styrene in the presence of 50 wt. %, based on the ABS polymer, of a particulate crosslinked polybutadiene rubber (mean particle diameter d50=0.25 μm) and 50 wt. % of a copolymer of 77 wt. % styrene and 23 wt. % acrylonitrile having a weight-average molecular weight Mw of 130,000 g/mol (determined by GPC with polystyrene as standard), prepared by the mass polymerisation process. The following alkali and alkaline earth metal contents were determined in this graft polymer by means of ICP-OES: Li<2 ppm, Na: 18 ppm, K: 65 ppm, Mg: 340 ppm and Ca: 8 ppm (indications <x meaning that the element could not be detected with the particular detection limit of the analytical method).

### Component C-1

Pentaerythritol Tetrastearate as Lubricant/Demoulding Agent

### Component C-2

Heat stabiliser, Irganox® B900 (mixture of 80% Irgafos® 168 and 20% Irganox® 1076; BASF AG; Ludwigshafen/Irgafos® 168 (tris(2,4-di-tert-butyl-phenyl) phosphite)/Irganox® 1076 (2,6-di-tert-butyl-4-(octadecanoxycarbonylethyl)phenol)

Preparation and Testing of the Moulding Compositions

The materials listed in Table 1 are compounded on a twin-screw extruder (ZSK-25) (Coperion, Werner and Pfleiderer) at melt temperatures, measured with a thermoelement at the extruder die, of 260° C., 285° C. and 310° C. and then granulated after cooling in a water bath. The different melt temperatures were set by varying the specific energy input in the compounding by varying the screw speed and the throughput. The finished granules are processed to the corresponding test specimens on an injection-moulding machine (Arburg) at melt temperatures of 260° C., 280° C. and 320° C. and a mould temperature of in each case 80° C. The following methods were used to characterise the properties of the moulding compositions:

The ESC behaviour was measured in accordance with ISO 4599 at room temperature and with an outer fibre strain of 2.4% in rape oil on test rods measuring 80 mm×10 mm×4 mm, which had been injection moulded at a melt temperature of 260° C.

As a measure of the processing stability in respect of polycarbonate molecular weight degradation of the compositions that are prepared there is used the percentage change in the MVR measured in accordance with ISO 1133 at 260° C. and with a load of 5 kg on exposure of the melt for 15 minutes, with the exculsion of air, at a temeprature of 300° C. The resulting parameter AMVR(proc.) is calculated according to the following formula:

$$Δ MVR ( proc . ) = \frac{MVR ( after storage of the melt ) - MVR ( before storage )}{MVR ( before storage )} \cdot 100 \%$$

The gloss level is measured in reflection at a measuring angle of 60° in accordance with DIN 67530 on sheets measuring 60 mm×40 mm×2 mm, which were produced at a melt temperature of 280° C. or 320° C. by injection moulding using a mould having a high gloss polished surface. The reduction in the gloss level in percent when the processing temperature in the injection moulding is raised from 280° C. to 320° C. is used as a measure of the processing stability of the gloss level.

The content of free bisphenol A was determined on the granules of the moulding compositions compounded at a melt temperature, measured with a thermoelement at the extruder die, of 285° C. and 310° C.

The examples which follow serve to explain the invention in greater detail.

TABLE 1

| | 1 | C1 | C2 | C3 | 2 | 3 |
|---|---|---|---|---|---|---|
| A1 | 70 | 70 | — | — | — | — |
| A2 | — | — | 70 | 70 | — | — |
| A3 | — | — | — | — | 70 | — |
| A4 | — | — | — | — | — | 70 |
| B1 | 30 | — | 30 | — | 30 | 30 |
| B2 | — | 30 | — | 30 | — | — |
| C1 | 0.5 | 0.5 | 0.5 | 0.5 | 0.5 | 0.5 |
| C2 | 0.1 | 0.1 | 0.1 | 0.1 | 0.1 | 0.1 |
| Properties | | | | | | |
| BPA content (compound. temp. 285° C.) | 11 | 25 | 69 | 72 | n.m. | n.m. |
| BPA content (compound. temp. 310° C.) | 11 | 45 | 93 | 90 | n.m. | n.m. |
| Increase in BPA content (285→310° C.) | 0% | 80% | 35% | 25% | n.m. | n.m. |
| ESC (rape oil, time to fracture) [h] | 19 | 2.3 | 3.3 | 1.2 | n.m. | n.m. |
| Gloss level (60°); injection moulding at 280° C. | 98 | 90 | 97 | 85 | 99 | 98 |
| Gloss level (60°); injection moulding at 320° C. | 94 | 55 | 80 | 56 | 94 | 96 |
| Reduction in gloss level (280→320° C.) | 4% | 39% | 18% | 34% | 3% | 2% |
| deltaMVR(300° C./15 min) [%] | 51% | 132% | 70% | 260% | 152% | 262% |

n.m. = not measured

It is clear from Examples 1 to 3 and Comparative Examples C1 to C3 in Table 1 that only the compositions according to the invention of Examples 1 to 3, which comprise on the one hand a polycarbonate having a low OH end group content and on the other hand an ABS graft polymer having a low content of lithium, sodium, potassium, magnesium and calcium, exhibit the desired property profile.

Examples 2 and 3, which differ from Example 1 only by a higher content of free bisphenol A in the polycarbonate component, likewise exhibit very good processing stability in respect of the maintenance of the gloss level when the processing temperature is increased, but they have poorer processing stability in respect of polycarbonate degradation.

Comparative Example 1 comprising polycarbonate having a low OH end group content and an ABS graft polymer having a high content of lithium, sodium, potassium, magnesium and calcium exhibits markedly poorer ESC behaviour and poorer processing stability in respect of gloss level, polycarbonate degradation and residual bisphenol A content.

Comparative Example 2 comprising polycarbonate having a high OH end group content and having a higher content of free bisphenol A, and an ABS graft polymer having a low content of lithium, sodium, potassium, magnesium and calcium likewise exhibits significantly poorer ESC behaviour and poorer processing stability in respect of gloss level, polycarbonate degradation and residual bisphenol A content.

Comparative Example 3 comprising both polycarbonate having a high OH end group content and having a higher content of free bisphenol A, and an ABS graft polymer having a high content of lithium, sodium, potassium, magnesium and calcium likewise exhibits significantly poorer ESC behaviour and poorer processing stability in respect of gloss level, in particular polycarbonate degradation and residual bisphenol A content.

1. A thermoplastic moulding composition comprising:
A) from 40.0 to 99.5 parts by weight of at least one aromatic polycarbonate or polyester carbonate having an OH end group content of not more than 300 ppm,
B) from 0.5 to 60.0 parts by weight of at least one graft polymer comprising lithium, sodium, potassium, magnesium and calcium of not more than 100 ppm in total,
C) from 0.0 to 30.0 parts by weight of vinyl copolymer, and:
D) from 0.0 to 40.0 parts by weight of at least one polymer additive,
wherein the sum of the parts by weight of components A) to D) is 100 parts by weight.

2. The moulding composition according to claim 1, wherrein said component A comprises free bisphenol A (BPA) of not more than 20 ppm.

3. The moulding composition according to claim 1, wherein said component A has been prepared by an interfacial process.

4. The moulding composition according to claim 1, wherein said component B is a graft polymer of:
B1) from 80 to 93 wt. %, based on component B, of a mixture of:
B1.1) from 70 to 80 wt. %, based on the mixture B1, of at least one monomer selected from the group consisting of vinyl aromatic compounds, vinyl aromatic compounds substituted on the ring, and methacrylic acid (C1-C8)-alkyl esters, and:
B1.2) from 20 to 30 wt. %, based on the mixture B1, of at least one monomer selected from the group consisting of the vinyl cyanides, (meth)acrylic acid (C1-C8)-alkyl esters and derivatives of unsaturated carboxylic acids,
on
B2) from 20 to 7 wt. %, based on component B, of at least one graft base comprising a glass transition temperature<−50° C.

5. The moulding composition according to claim 1, wherein said component B is prepared by mass and/or solution polymerisation process.

6. The moulding composition according to claim 1, wherein said composition is free of aromatic polycarbonate or polyester carbonate prepared by a melt polymerisation process.

7. The moulding composition according to claim 1, wherein said composition is free of graft polymers and vinyl copolymers prepared by an emulsion or suspension polymerisation process.

8. The moulding composition according to claim 1, wherein said component A comprises an OH end group content of not more than 200 ppm.

9. The moulding composition according to claim 1, wherein said component B comprises lithium, sodium, potassium, magnesium and calcium of not more than 20 ppm in total.

10. The moulding composition according to claim 2, wherein said component A comprises free bisphenol A of not more than 10 ppm.

11. The moulding composition according to claim 1, wherein free bisphenol A in the composition as a whole is not more than 20 ppm and is at least 0.5 ppm.

12. The moulding composition according to claim 1, comprising:
A) from 50.0 to 95.0 parts by weight of at least one aromatic polycarbonate and/or polyester carbonate having an OH end group content of not more than 300 ppm,
B) from 4.5 to 49.5 parts by weight of at least one graft polymer comprising lithium, sodium, potassium, magnesium and calcium of not more than 100 ppm in total,
C) from 0.0 to 20.0 parts by weight of vinyl (co)polymer, and;
D) from 0.5 to 20.0 parts by weight of 1 at least one polymer additive.

13. The moulding composition according to claim 1, comprising:
A) from 60.0 to 90.0 parts by weight of at least one aromatic polycarbonate and/or polyester carbonate having an OH end group content of not more than 300 ppm,
B) from 6.0 to 36.0 parts by weight of at least one graft polymer comprising lithium, sodium, potassium, magnesium and calcium of not more than 100 ppm in total,
C) from 3.0 to 15.0 parts by weight of vinyl (co)polymer, amd;
D) from 1.0 to 10.0 parts by weight of at least one polymer additive.

14. The moulding composition according to claim 1, wherein said component A comprises a mean weight-average molecular weight M_{w} of from 26,000 to 32,000 g/mol.

15. The moulding composition according to claim 1, wherein said composition comprises as component D at least one selected from the group consisting of flameproofing agents, flameproofing synergists, smoke-inhibiting additives, antidripping agents, internal and external lubricants and demoulding agents, flowability aids, antistatics, conductivity additives, UV stabilisers, light stabilisers, heat stabilisers, antioxidants, transesterification inhibitors, hydrolytic stabilisers, additives having antibacterial action, additives that improve scratch resistance, IR absorbers, optical brighteners, fluorescent additives, fillers and reinforcing materials, acids, colourants and pigments.
